(19) United States
(12) Patent Application Publication
(10) Pub. No.: US 2009/0158054 A1
(43) Pub. Date: Jun. 18, 2009

(54) PRIVATE DATA PROCESSING

(75) Inventors: Marten Van Dijk, Somerville, MA (US); Jing Chen, Cambridge, MA (US); Srinivas Devadas, Lexington, MA (US)

Correspondence Address: OCCHIUTI ROHLICEK & TSAO, LLP, 10 FAWCETT STREET, CAMBRIDGE, MA, 02138, US

(73) Assignee: Massachusetts Institute of Technology, Cambridge, MA (US)

(21) Appl. No.: 12/335,083

(22) Filed: Dec. 15, 2008

Related U.S. Application Data
(60) Provisional application No. 61/013,373, filed on Dec. 13, 2007.

(51) Int. Cl. G06F 12/14; G06F 7/06; G06F 17/30

(52) U.S. Cl. 713/189; 707/5; 707/E17.008; 707/E17.014; 707/E17.044

(57) ABSTRACT

A method for processing one or more terms includes, at a first computation facility, computing an obfuscated numerical representation for each of the terms. The computed obfuscated representations are provided from the first facility to a second computation facility. A result of an arithmetic computation based on the provided obfuscated values is received at the first facility. This received result represents an obfuscation of a result of application of a first function to the terms. The received result is processed to determine the result of application of the first function to the terms.

### CROSS-REFERENCE TO RELATED APPLICATIONS

This application claims the benefit of U.S. Provisional Application No. 61/013,373, filed Dec. 13, 2007, and titled “Private Data Access”, which is incorporated herein by reference.

### BACKGROUND

This invention relates to private data processing, for example, that preserves privacy of a data request and/or data retrieved in response to the request.

It can be desirable for a client computer to access data on a server in a private way, for example, in a way in which the specification of data being requested or searched for is impossible or difficult for the server to determine and in which the selection of data that satisfies the request is also not known to the server. For example, in a search application, it can be desirable for a client to provide a set of search terms to a server, and for the server to identify files that have all the terms in them to the client in a way that preserves the privacy of the client's request and the corresponding result. Similarly, it can be desirable for the client to be able to obtain one of more selected files from the server (e.g., the files identified in a prior confidential query) without disclosing the identities of those files to the server.

Prior techniques can have limitations, such as a limit on the number of terms that can be combined (e.g., ANDed) in a query, or limitations related to the amount of data that needs to be transferred to achieve the desired privacy.

### SUMMARY

In one aspect, in general, a method for processing one or more terms includes, at a first computation facility, computing an obfuscated numerical representation for each of the terms. The computed obfuscated representations are provided from the first facility to a second computation facility. A result of an arithmetic computation based on the provided obfuscated values is received at the first facility. This received result represents an obfuscation of a result of application of a first function to the terms. The received result is processed to determine the result of application of the first function to the terms.

Aspects may include one or more of the following:

The first function represents an identification of one or more data items available to the second facility that are each associated with each of the one or more terms. For example, each term represents a corresponding keyword, and the data items represent documents, such that the first function represents a retrieval of identifications of documents that include all the keywords.

The one or more terms are maintained to be private to the first facility without disclosure to the second facility.

A specification of the first function is provided from the first facility to the second facility.

Computing the obfuscated numerical representation of each of the terms includes applying an obfuscation operator, wherein applying the obfuscation operator includes mapping an argument of the operator to a substantially random value of a range of numerical values, the range of numerical values being selected from pre-determined ranges based on the value of the argument.

Applying the obfuscation operator further includes adding a random multiple of a number. For example, this number is based on one or more prime numbers.

The pre-determined ranges comprise a first range of values and a second range of values, all the values in the first range being substantially smaller than all the values in the second range.

Computing the obfuscated numerical representation of each of the terms includes applying an obfuscation operator, wherein applying the obfuscation operator includes mapping an argument of the operator to set of numbers, each number based on the argument and a corresponding reference number.

The reference numbers are relatively prime, and the each of the set of numbers is based on a modulus of the argument and the reference number.

The first facility comprises a client process and the second facility comprises a server process, the client and server processes being coupled by a data link.

The first function comprises an integer arithmetic function. For example, the arithmetic function comprises a sum of quantities.

The first function comprises a combination of a selection of a plurality of quantities known to the second facility, the selection being maintained private from the second facility.

The first function comprises a Boolean expression. In some examples, the Boolean expression includes both conjunction and disjunction. In some examples, the Boolean expression includes at least one term comprising a conjunction of three or more sub-expressions. In some examples, the Boolean expression is in conjunctive normal form. In some examples, the Boolean expression is in disjunctive normal form.

In another aspect, in general, presence of a desired identifier in a set of identifiers is determined. The desired identifier and each in the set of identifiers being represented as a series of values from a domain of valid values. The method includes, for each of the series of values of the desired identifier, computing a corresponding obfuscated representation of said value. The obfuscated representations of the values are then provided. A numerical value is received, the value being computed based on the provided obfuscated representations and the representations of the identifiers in the set. Whether the desired identifier is present in the set of identifiers is determined based on the received numerical value.

Aspects may include one or more of the following:

The domain of valid values consist of the possible bit values, and each of the series of values consists of a binary representation of a corresponding identifier.

Providing the obfuscated representations of the values includes, for each of the values providing an obfuscated representation associated with each of the values in the domain of valid values.

Obfuscated representations of the series of values representing each of a series of identifiers specifying a desired phrase are provided. Then, whether the desired phase is present is a document is determined according the received numerical value.

In another aspect, in general, a method is used to determine presence of each of three or more desired identifiers in a set of identifiers. The method includes, for each of the desired identifiers, computing a corresponding obfuscated representation of said desired identifier. The obfuscated representations of the identifiers are provided, and a numerical value is received, the value being computed based on the provided obfuscated representations and the identifiers in the set. Whether all of the desired identifiers are present in the set of identifiers is determined based on the received numerical value.

Aspects may include one or more of the following:

Each of at least some of the identifiers is associated with presence of a corresponding term.

Each of at least some of the identifiers is associated with absence of a corresponding term.

In another aspect in general, a data processing system includes a first computation facility configured to compute an obfuscated numerical representation for each of a set of one or more terms known to the first facility. The system also includes a second computation facility configured to receive the computed obfuscated representations from the first entity to a second facility and to compute a result of an arithmetic computation based on the received obfuscated values, the result representing an obfuscation of a result of application of a first function to the terms. The first computation facility is further configured to receive the result from the second facility and to process the result to determine the result of application of the first function to the terms.

In another aspect, in general, software stored on computer-readable media includes instructions for causing a data processing system to: at a first computation facility, compute an obfuscated numerical representation for each of the terms; provide the computed obfuscated representations from the first facility to a second computation facility; receive at the first entity a result of an arithmetic computation based on the provided obfuscated values representing an obfuscation of a result of application of a first function to the terms; and process the received result to determine the result of application of the first function to the terms.

Aspects may have one of more of the following advantages:

Obfuscating the terms provides a degree of privacy to a first facility so that the second facility cannot easily determine the terms known to the first facility. The form of obfuscation nevertheless allows a second facility to perform computation (e.g., integer function evaluation) on behalf of the first facility and return a quantity that permits the first facility to recover the desired result.

Having a second facility perform the computation for the first facility can have an advantage of making use of computer resources not available to the first facility. For example, these resources may include processing resources (e.g., CPU cycles), or storage resources, such as storage of documents or indexes of documents.

Providing a facility for private evaluation of integer functions provides way to compute other types of functions by representing those other types of functions as corresponding integer functions. For example, Boolean functions, data selection, and keyword based search, can be represented as integer function evaluation.

Use of numerical obfuscation, for example, using interval based mapping, provides a more efficient approach than applying certain other cryptographic techniques.

Aspects can provide a way to privately compute more complex expressions (e.g., more complex Boolean expressions) than possible using any previous techniques.

Other features and advantages of the invention are apparent from the following description, and from the claims.

### BRIEF DESCRIPTION OF THE DRAWINGS

FIGS. 1a, 1b, and 1c are diagrams of a private data access system.

FIG. 2 is a flowchart.

FIG. 3 is a diagram that illustrates obfuscation operations.

### DESCRIPTION

### 1 Overview

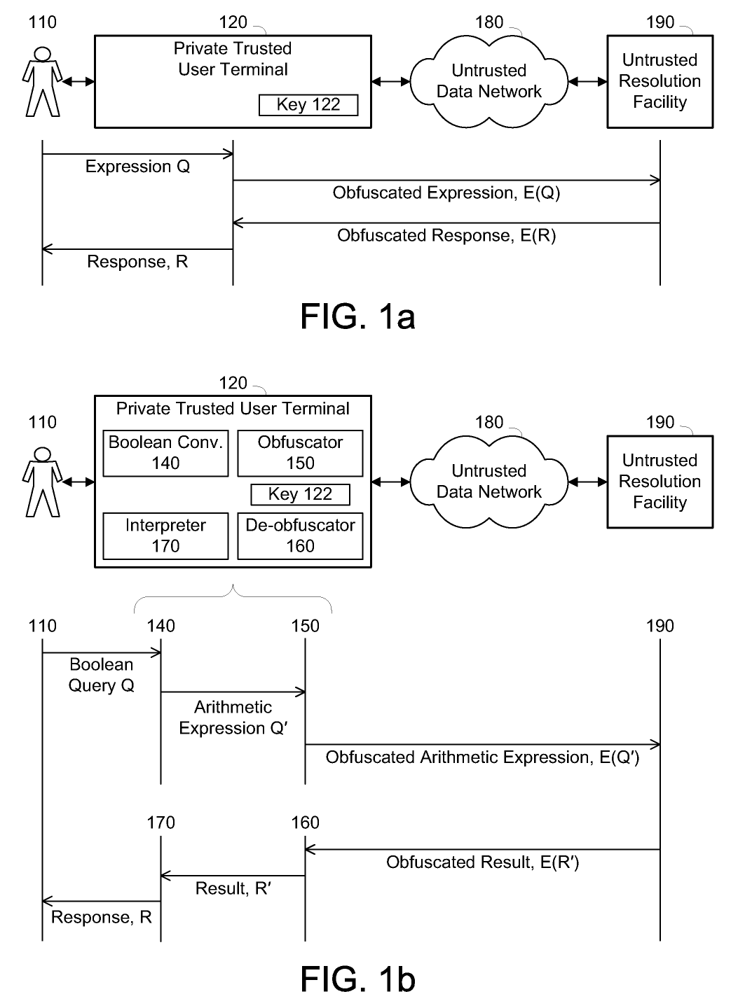

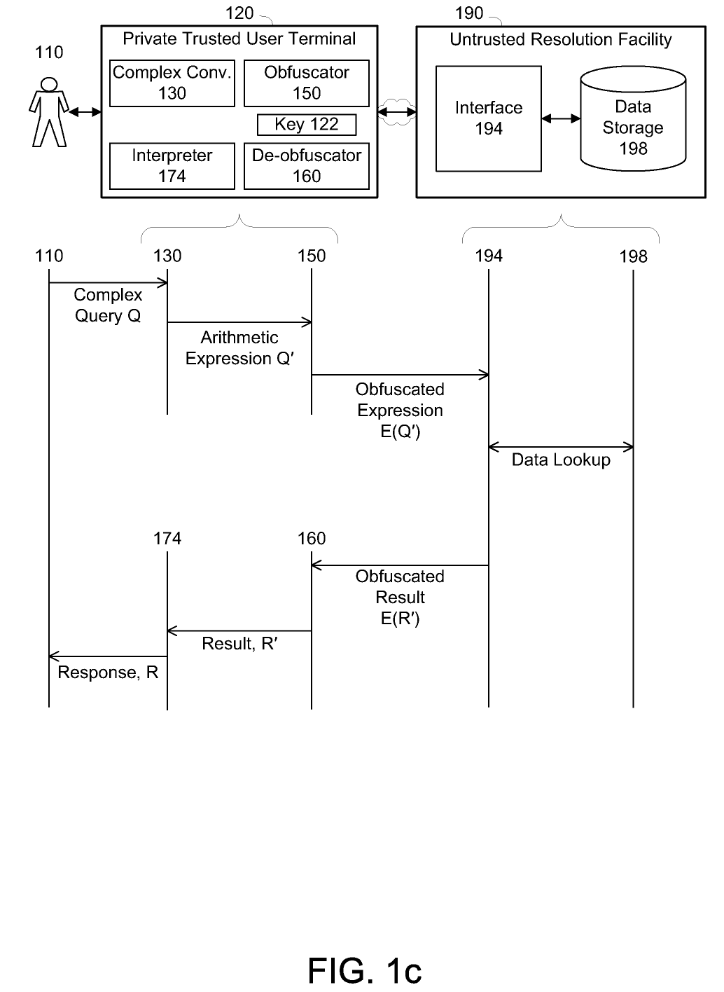

A number of approaches described below take advantage of an underlying technique that permits arithmetic expressions to be evaluated by an untrusted facility while obfuscating the values of the terms in the expression and the result so that the untrusted facility learns only the form of the expression. Referring to FIG. 1a, these approaches permit a user 110 using a private trusted user terminal 120 (a trusted facility) to specify an expression Q at a private trusted user terminal 120 desiring to receive a response R, which includes an evaluation of the expression Q using data that is accessible by the untrusted facility. Generally, the approach used in one or more of the embodiments described below is for the trusted user terminal 120 to provide an obfuscated expression E(Q) to an untrusted resolution facility 190 over an untrusted data network 180, for example, over the public Internet. In return, the untrusted facility 190 returns an obfuscated result E(R), from which the trusted terminal 120 determines the desired result R.

In this specification, to “obfuscate” information means to conceal the information such that it is not evident in the obfuscation. One way to obfuscate information is to apply an encryption algorithm, such as a public key encryption algorithm, however, such a strong encryption approach is not necessarily required to achieve obfuscation of the information.

In some examples the untrusted resolution facility includes a computer configured to receive requests and provide responses (e.g., a data server). The computer is also configured to access a collection of data to be queried using obfuscated queries. For example, the collection of data can be a database, a catalog, an atlas, navigational data, a collection of keywords for media, or media content. Media includes text, maps, books, still images, audio, video, and audio-visual compilations. Media can include anything that may be recorded in digital form. In some examples, the collection of data represents materials not hosted by the facility (e.g., an index of tangible media available in a library). The untrusted facility is generally trusted to return a correct result (as the user can generally verify the result). The facility is untrusted primarily from a privacy perspective.

Continuing to refer to FIG. 1a, using approaches described below, it is computationally difficult or impracticable for the untrusted resolution facility 190 (or any other observer monitoring the network 180) to determine the value of each of the expression's terms, yet the facility is still able to carry out evaluation of the expression and returning an obfuscated result back to the terminal 120 where it is de-obfuscated for the user 110.

An underlying approach used in one or more embodiments is for the trusted terminal 120 to determine an expression Q to be evaluated, for example, by receiving a specification of the expression from the user 110, or as a result of a processing of a request from the user. In general, the expression Q includes a function, c(•), and arguments, u, such that the desired response, R, includes an evaluation of c(u). Note that in addition to the arguments, u, the function generally refers to data that is available to the untrusted facility 190, but that is generally not held by the private terminal 120. That is, the private terminal takes advantage of computational resources and/or data stored at the untrusted facility. The terminal 120 forms the obfuscated expression, E(Q), and transmits it over the network 180 to the resolution facility 190. The facility 190 resolves the expression E(Q) and returns a response E(R), which is also obfuscated. The trusted terminal 120 de-obfuscates the response (e.g., using secret key information 122) to determine the actual response R to the original expression Q, which in some examples, it returns to the user 110.

As discussed further below, the basic transaction that enables a trusted terminal 120 to have the untrusted terminal 190 evaluate an expression using obfuscated numeric values (e.g., positive integers) makes it possible for the user 110 to supply complex queries that the user terminal 120 converts into an obfuscated arithmetic expression for processing by an untrusted resolution facility 190. For example, referring to FIG. 1b, the user 110 supplies an arbitrary Boolean query Q to the terminal 120. Within the terminal 120, a Boolean convertor 140 converts the expression to an arithmetic expression Q′ and an obfuscator 150 obfuscates the expression creating an obfuscated arithmetic expression E(Q′). Then, as before, the terminal 120 transmits the obfuscated arithmetic expression E(Q′) to the resolution facility 190. The facility 190 returns an obfuscated result E(R′) to the user terminal 120. Within the terminal 120, a de-obfuscator 160 de-obfuscates the result R′ and an interpreter 170 determines the actual response R to the original Boolean query Q. The terminal 120 returns this response R to the user 110.

Referring to FIG. 1c, even more complex queries can be processed in a similar manner, as will be shown. For example, the user 110 can query for binary data (e.g., a sequence of bits, which may form one or more query words W) in a particular file or set of files {F₁, F₂, . . . Fₙ}. In some examples, the user may also (through obfuscation) avoid disclosing which file the user is actually interested in. The user 110 forms a complex query Q and submits it to the private trusted user terminal 120. A complex query converter 130 converts the complex query Q into an arithmetic expression Q′, which is then obfuscated as before by the obfuscator 150. In some examples, the complex query Q relates to data accessible to the untrusted resolution facility 190 (e.g., within data storage 198).

The untrusted resolution facility 190 receives the obfuscated expression E(Q′) where an interface 194 processes the expression facilitated by data lookups to the data storage 198. While the data storage 198 is depicted as being within the resolution facility 190, it may alternatively be merely accessible by the facility (e.g., over a data network). As before, the untrusted resolution facility 190 returns an obfuscated result to the user terminal 120. There, a de-obfuscator 160 processes the result E(R′) to obtain a non-obfuscated result R′ and an interpreter 174 correlates the result R′ to a proper response R for the user 110 in light of the complex query Q.

In each case, the values of terms are obfuscated such that it is impossible or impracticable for the untrusted resolution facility 190, and/or any other untrusted observers, to determine the values—yet the facility 190 is able to provide a useful response. These are just the example uses detailed here. Many forms of query can be converted into an arithmetic expression and obfuscated in similar manner.

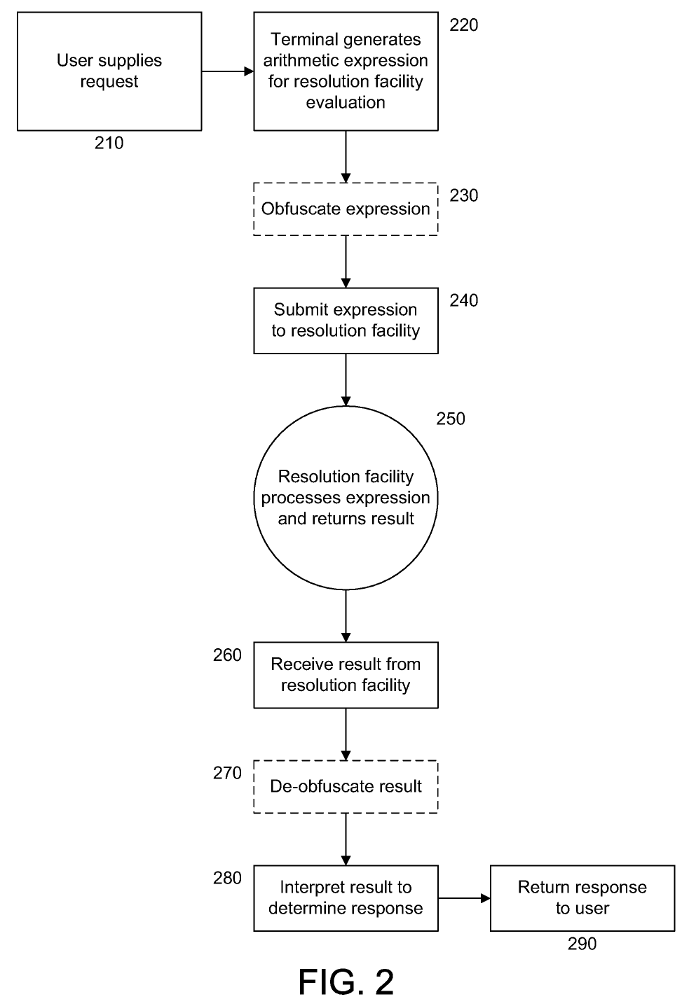

Referring to FIG. 2, the general approach described above can be represented in a flowchart in which a user first supplies a request to the trusted terminal (210). The trusted terminal generates an arithmetic expression for resolution facility evaluation (220). The terminal obfuscates the arithmetic expression (230) and submits the obfuscated expression to the resolution facility (240). The resolution facility processes the expression and returns a result—an obfuscated response (250). The trusted terminal receives the result from the facility (260) and de-obfuscates the result (270). The terminal then interprets the result to determine the response (if necessary) (280). And finally, the response is returned to the user.

Note that this process could work without the obfuscation (230) and subsequent de-obfuscation (270). That is, the arithmetic expression could be transmitted to the facility without obfuscation and the facility could resolve the expression and return a useful response. The obfuscation is therefore addressed separately from the formation of the arithmetic expression.

### 2 Obfuscated Arithmetic Expressions

Before continuing with examples of Boolean or complex queries, multiple embodiments of arithmetic obfuscation schemes are presented. These are used to demonstrate that an arithmetic expression can be obfuscated and evaluated in obfuscated form. Then several approaches to conversion of complex queries to arithmetic expressions are presented. In each of these embodiments of arithmetic obfuscation two functions are defined—a function ρ(x) defined to obfuscate a value x (generally a whole number less than a specified maximum); and a function ρ⁻¹(x) defined to de-obfuscate a value x, that is, ρ⁻¹(ρ(x))=x. De-obfuscation generally uses private information, e.g., a secret key held by a user terminal. In some embodiments, a new key is generated for each query.

Additionally, it is helpful to look at arithmetic expressions as nested multiplication and addition of terms. If the trusted terminal wishes to compute the multiplication of two numbers, x×y, it computes the obfuscation of the numbers, ρ(x) and ρ(y), and the untrusted facility computes a function FC (ρ(x), ρ(y)). This function is such that ρ⁻¹ (FC(ρ(x),ρ(y)))=x×y. Similarly, for addition, a function FD is applied at the untrusted facility such that ρ⁻¹(FD(ρ(x), ρ(y)))=x+y. Similarly, the untrusted facility can multiply or add an obfuscated number by a number known to the untrusted facility, for example, such that ρ⁻¹(FM(ρ(x), y))=x×y and ρ⁻¹(FA(ρ(x),y))=x+y.

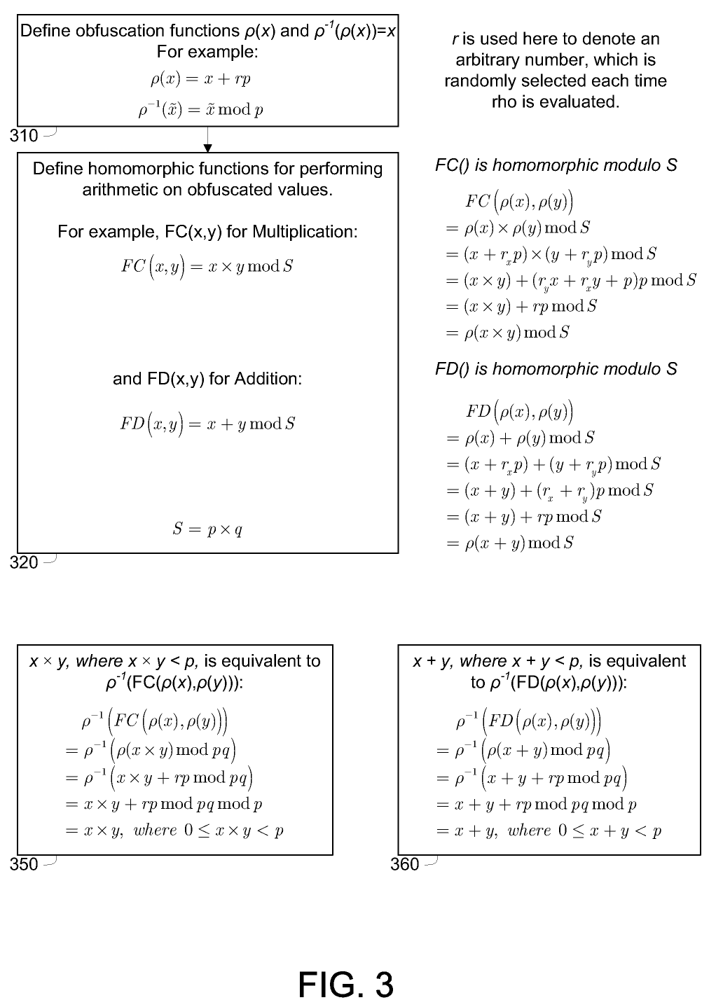

Referring to FIG. 3, one example obfuscation scheme relies on a pair of large prime numbers p and q. (Alternatively, p and/or q may also be a composite number with only large prime number factors). The number p is chosen to be large enough such that the arguments and arithmetic result are all guaranteed to be less than p. S, the product of p and q, is made public (for example, accompanies the obfuscated query) and p is preserved as a secret key. The obfuscation function is ρ(x)=x+rp, where r is a number drawn at random for each evaluation of ρ( ) (310). The de-obfuscation function is ρ⁻¹(\tilde{x})=\tilde{x} mod p, which can be understood to be the inverse of the obfuscation function because ρ⁻¹(ρ(x))=(x+rp)mod p=x. Note that “mod” is used here as a mathematical term for modulo. Modulo arithmetic, sometimes called remainder arithmetic, is arithmetic performed in a number space such that values are retained between 0 and an upper-limit; under-flow and over-flow are wrapped around in a ring-like manner.

Next, the scheme defines homomorphic (structure preserving) functions by which the untrusted facility performs arithmetic on obfuscated values (320).

FC(x, y)=(x×y)mod S

FD(x,y)=(x+y)mod S.

As is shown, using FC( ) to compute the product of two numbers x & y, each obfuscated using ρ( ), produces the equivalent of obfuscating the product x×y using ρ( ). Likewise, using FD( ) to compute the sum of two numbers x & y, each obfuscated using ρ( ), produces the equivalent of obfuscating the sum x+y using ρ( ). Similarly the functions for addition and multiplication by known numbers correspond to addition and multiplication modulo S. In the discussion below, when clear from the context, computation of FC( ) and FD( ) by the untrusted facility are represented using the symbols for multiplication and addition, respectively, for ease of notation, recognizing that depending on the obfuscation function, these operators may have particular implementations.

The arithmetic is performed by the untrusted facility modulo S to avoid overflow. In some embodiments, S is not used, and the untrusted facility performs arithmetic over the non-negative integers with the same effect. Note that ρ⁻¹(\tilde{x} mod S)=ρ⁻¹(\tilde{x}) because a number modulo pq modulo p is equal to that number modulo p. Therefore, performing the arithmetic modulo S at the untrusted facility is optional and does not interfere with the later operation of ρ⁻¹( ). This is demonstrated for multiplication (350) and addition (360).

As a second embodiment of obfuscation and deobfuscation operators, the functions ρ( ) and ρ⁻¹( ), and corresponding addition and multiplication functions are defined as follows:
ρ(x)=[x mod m₁, x mod m₂, . . . , x mod mₜ]=[\tilde{x}₁, . . . , \tilde{x}ₜ], which is a vector of t elements determined by the trusted facility according to a set of secret coprime numbers m₁, . . . , mₜ, with

$$M = {\prod }_{i = 1}^{t} {m}_{i} ,$$

and the coprime numbers chosen such that the arguments and de-obfuscated arithmetic results are all less than M.
ρ⁻¹([\tilde{x}₁, . . . \tilde{x}ₜ]) is computed using the Chinese Remainder Theorem, specifically as

$${ρ}^{- 1} ( [ {\tilde{x}}_{1} , … , {\tilde{x}}_{t} ] ) = ( {\sum }_{i = 1}^{t} ( {x}_{i} mod {m}_{i} ) {e}_{i} ) mod M$$

where the numbers eᵢ are chosen such that each eᵢ is divisible by all mⱼ j≠i, (i.e., eᵢ≡0(mod mⱼ) ∀_{i≠j}), and eᵢ is one greater than a multiple of mᵢ (i.e., eᵢ≡1 (mod mᵢ)).
The functions FC( ) and FD( ) are element-wise multiplication and addition, respectively, and the functions FM( ) and FA( ) are similarly performed element-wise.

In an alternative embodiment that combines aspects of the other embodiments, obfuscation can further introduce a random multiple of mᵢ into the ith element of ρ(x), e.g., ρ(x)=[x mod m₁+r₁m₁, x mod m₂+r₂m₂, . . . , x mod mₜ+rₜmₜ]=[\tilde{x}₁, . . . , \tilde{x}ₜ ] ρ⁻¹([\tilde{x}₁, . . . , \tilde{x}ₜ]) is defined as before.

Referring back to FIG. 1b, when the user 110 supplies an arbitrary Boolean query Q to the private trusted user terminal 120, the trusted terminal applies a Boolean convertor 140 to convert the Boolean expression to an arithmetic expression Q′. Then an obfuscator 150 obfuscates and the terminal 120 transmits the obfuscated arithmetic expression E(Q′) to the untrusted resolution facility 190. The facility resolves the expression and returns an obfuscated result E(R′) to the terminal 120. A de-obfuscator 160 de-obfuscates E(R′) using secret key information 122 to obtain the actual numerical result R′. An interpreter 170 interprets the result R′ producing a Boolean response R (which is, for example, either True or False). The terminal 120 then returns the Boolean response R to the user 110.

### 3 Boolean Expressions

As an obfuscation scheme for arithmetic expressions has already been shown above, the focus now is on converting a Boolean expression into an arithmetic expression. In a first example of converting Boolean expressions to arithmetic expressions, each Boolean value is converted to a whole number as either Bool(True)=1 and Bool(False)=0. With this approach, X OR Y is evaluated by the untrusted facility as an obfuscation of Bool(X)+Bool(Y), and X AND Y is evaluated as an obfuscation of Bool(X) x Bool(Y). Conversion from an arithmetic result to a Boolean result then corresponds to comparison with one, such that true corresponds to a value greater than or equal to one, and false corresponds to a value less than one.

In a second example for converting Boolean expressions to arithmetic expressions, each Boolean value becomes either the pair (0,1) for true, or (1,0) for false. These pairs are then obfuscated as (ρ(0), ρ(1)) or (ρ(1), ρ(0)), respectively. The Boolean functions AND and OR correspond to element-wise multiplication and addition, respectively, and the Boolean function NOT corresponds to interchange of the elements of the pair, which can be represented as FN((x, y))=(y,x). Therefore, any Boolean expression can be converted to a nesting of the obfuscated functions FC( ) and FD( ), described above, and FN( ).

A preferable third example for mapping Boolean values to numbers uses an interval approach. Rather than using 1 to represent True and 0 to represent False, a range of relatively large numbers (referenced generically as “b”) is used to represent True and a range of relatively small numbers (referenced generically as “a”) is used to represent False. Specifically, a and b are chosen at random in the trusted domain as:

$$Bool ( X ) \{ \begin{matrix}a ∈ [ 0 , A ) & if X = False \\ b ∈ [ B , B + A ) & if X = True\end{matrix}$$

where the values A and B are chosen such that A<B and B+A is within the acceptable range of integers for the obfuscation operator, that is, less than p or less than M for the two examples of obfuscation approaches described above. Generally, A and B are chosen such that the untrusted facility can apply multiplication and addition to effect AND and OR operations, with Boolean result of True corresponding to the arithmetic result being in a particular large range. Generally, the trusted facility applies a secret threshold T selected to distinguish between large numbers and small results to recover the Boolean result.

In general, the threshold T depends on the values of A and B and the form of the expression being computed. For example, a disjunction (logical or) of N terms corresponding to false will be less than NA and must be less than the threshold. Similarly a conjunction (logical and) of N terms corresponding to false will be less than A(B+A)^{N-1}, but if corresponding to true will be at least B^{N}. And, of course, the maximum result must still be less than the upper bound for the obfuscation operator, e.g., p. A threshold fulfilling these requirements is generally suitable. Other approaches to determining suitable ranges for small and big arguments, and a corresponding threshold follow from similar reasoning for more complex expressions.

Note that it is important for the user terminal to be able to determine the correct threshold after a conjunction (logical-and) of N terms, where the threshold is B^{N}. One technique for this is to place the Boolean query in a normal form, for example, conjunctive normal form (“CNF”). CNF is a conjunction (logical-and) of disjunctions (logical-or) of the propositional variables. In CNF, the logical-or clauses are all independent of the logical-and clauses. Disjunctive normal form (“DNF”) may also be used, with an accounting for conjunctions of different numbers of terms. DNF is a disjunction of conjunctions of the propositional variables. In DNF, the logical-and clauses are all independent of the logical-or clauses. Using a normalized form makes it easy to determine the maximal number of each operation type. It is well known in the art that all Boolean phrases may be re-written into a logically equivalent CNF or DNF.

As an example of a method of setting a threshold for the de-obfuscation operation, Suppose we want to evaluate

OR_{1≦i≦t}_{_{OR}}(AND_{1≦j≦t}_{ᵢ}X_{i,j})

Let t_{AND}=max_{1≦i≦t}_{_{OR}}tᵢ and define E(R′)=Σ₁<=i<=t_{_{OR}}B^{t}^{_{AND}}^{-t}^{ᵢ}Π_{1<=j<=t}_{ᵢ}ρ(Bool(X_{i,j}))

where addition and multiplication uses FC/FD/FM/FA. Compute R′ as R′=ρ⁻¹(E(R′)). Then:

$$R = \{ \begin{matrix}True & if {R}^{′} \geq {B}^{{t}_{AND}} \\ False & if {R}^{′} < {t}_{OR} {A ( B + A )}^{{t}_{AND} - 1} .\end{matrix}$$

This works if t_{OR}A (B+A)^{t}^{_{AND}}⁻¹≦B^{t}^{_{AND}} or equivalently t_{OR}A (1+A/B)^{t}^{_{AND}}⁻¹≦B. If this condition holds, then de-obfuscation works for the threshold T=B^{t}^{_{AND.}}

A further fourth example encodes each Boolean value as a pair. In this case, a True value is encoded as (a,b) and a False value is encoded as (b,a) with the values a and b chosen as described above. In this way, a logical NOT (or equivalently an AND of negated values) can be performed by the untrusted facility.

### 4 Complex Queries

Other forms of query can be obfuscated in a manner similar to those described above for arithmetic expressions and Boolean queries. For example, a query for binary data at a requested index, and more generally, an evaluation of an arbitrary function of a binary input can be implemented as follows.

In a first approach the trusted facility (e.g., a private user terminal) forms a query for binary data. The untrusted facility holds a bit vector (c₁, c₂, . . . , c_{N}) and the user wishes to obtain the value of the v^{th} bit. The trusted facility sends a sequence (f₁, f₂, . . . , f_{N}), such that fᵢ=ρ(a) for i≠v and fᵥ=ρ(b), with a and b being independently randomly chosen for each element of the sequence from the small and large ranges, respectively, as discussed above. The untrusted facility then returns

$${\sum }_{j = 1}^{N} {c}_{j} {f}_{j} ,$$

and the trusted facility computes the inverse

$$r = {ρ}^{- 1} ( {\sum }_{j = 1}^{N} {c}_{j} {f}_{j} ) .$$

If the result r is in the large range (e.g., greater than B), the value of cᵥ is known to be 1. Note that A and B are chosen so that the sum of N “small” values is guaranteed to be less than B.

In a second approach, to avoid having to send all N values fᵢ, the desired index v is represented in binary form (u₁, . . . , uₙ), for N<2ⁿ, such that v=Σᵢuᵢ2ⁱ⁻¹. In this approach, if the user wishes to obtain the value of the v^{th} bit, the trusted facility sends a vector of pairs

f=((f₁(0),f₁(1)),(f₂(0),f₂(1)), . . . ,(fₙ(0),fₙ(1))),

such that

(fᵢ(0),fᵢ(1))=(ρ(a),ρ(b)) if uᵢ=1 and

(fᵢ(0),fᵢ(1))=(ρ(b),ρ(a)) if uᵢ=0,

with a and b being independently randomly chosen from the small and large ranges as discussed above. The values of the vector can be written as

(fᵢ(0),fᵢ(1))=(ρ(xᵢ(0)),ρ(xᵢ(1))) where

xᵢ (uᵢ)=b and xᵢ (1−uᵢ)=a are the interval encodings of the bits prior to obfuscation. Note that for all

$$j = {\sum }_{i} {w}_{i} {2}^{i - 1} \neq v$$

the product

$${\prod }_{i} {x}_{i} ( {w}_{i} )$$

has at least one small “a” term, and for

$$j = {\sum }_{i} {u}_{i} {2}^{i - 1} = v ,$$

the product

$${\prod }_{i} {x}_{i} ( {u}_{i} )$$

has only large “b” terms. The untrusted facility then returns

$${\sum }_{j = 1 , … , N} {c}_{j} {\prod }_{i} {f}_{j} ( {w}_{i} ) ,$$

where the wᵢ are the bit representation of

$$j = {\sum }_{i} {w}_{i} {2}^{i - 1}$$

where the addition and multiplication uses FC/FD/FM/FA.

The trusted facility then applies the de-obfuscation operator ρ⁻¹( ) compares the result to a threshold T corresponding to the smallest product of n “large” terms. If the result is greater than or equal to that threshold, then the v^{th} bit, cᵥ must be equal to 1, and otherwise it must be equal to 0.

In some implementations, the untrusted facility maintains a list D of indexes such that cⱼ=1 only for entries (index terms) jεD, and zero otherwise. In such a implementation, the untrusted facility computes and returns

$${\sum }_{j ∈ D} ( {\prod }_{i} {f}_{i} ( {w}_{i} ) ) ,$$

where the wᵢ are the bit representation of

$$j = {\sum }_{i} {w}_{i} {2}^{i - 1} .$$

In a third approach, the trusted facility desires to know whether all the bits in a query set {v₁, . . . , v_{Q}} are set at the untrusted facility. The trusted facility computes a separate vector f^{(q)} for each v_{q}, as described above, and then the untrusted facility computes and returns

$${\prod }_{q = 1}^{Q} ( {\sum }_{j ∈ D} ( {\prod }_{i} {f}_{i}^{( q )} ( {w}_{i} ) ) ) .$$

This quantity, after de-obfuscation, is above a threshold

$${\prod }_{q = 1}^{Q} ( {\prod }_{i} {x}_{i}^{( q )} ( {u}_{i}^{( q )} ) ) , with {v}_{q} = {\sum }_{1 \leq i \leq n} {u}_{i}^{( q )} {2}^{i - 1}$$

only when each of the Q query terms is above a threshold.

As an example usage, if the set D represents a set of word indices of words present in a particular document and the set of query indices {v₁, . . . , v_{Q}}represent the words that are to be tested for presence in the document, then the untrusted facility provides the obfuscated response sufficient for the trusted facility to determine whether the document has all the query words in it.

In a fourth approach, rather than the untrusted facility holding a bit vector, the untrusted facility has a vector of numbers (c₁, c₂, . . . , C_{N}), or equivalently a function c(u) that can be evaluated to determine the uth value in the vector. In this approach, the trusted facility desires to learn the value of a single v^{th} entry in the vector. In this approach, the trusted facility computes f=((f₁(0),f₁(1)), . . . ,(fₙ(0),fₙ(1))) corresponding to v as in the second approach described above. The untrusted facility then computes

$${\sum }_{j = 1 , … , N} c ( j ) {\prod }_{i} {f}_{i} ( {w}_{i} ) ,$$

where the wᵢ are the bit representation of j=Σᵢwᵢ2ⁱ⁻¹ and returns this quantity to the trusted facility, which applies the de-obfuscation operator to determine a numerical result. Note that after de-obfuscation, all the values c(i) other than the desired c(v) are multiplied by relatively small values

$${\prod }_{i} {x}_{i} ( {w}_{i} ) ,$$

as compared to the product corresponding to the desired value v. That is the de-obfuscated result

$$r = {ρ}^{- 1} ( {\sum }_{j = 1 , … , N} c ( j ) {\prod }_{i} {f}_{i} ( {w}_{i} ) ) = c ( v ) {\prod }_{i} {x}_{i} ( {u}_{i} ) + {\sum }_{j \neq v} c ( j ) {\prod }_{i} {x}_{i} ( {w}_{i} ) , \\ where v = {\sum }_{i} {u}_{i} {2}^{i - 1} ,$$

is the sum of a large term corresponding to the desired value of v and a sum of relatively small terms. The trusted facility then recovers c(v) by applying a division operator that provides the result truncating any remainder:

$$r div {\prod }_{i} {x}_{i} ( {u}_{i} ) = c ( v ) + ( {\sum }_{j \neq v} c ( j ) {\prod }_{i} {x}_{i} ( {w}_{i} ) div {\prod }_{i} {x}_{i} ( {u}_{i} ) ) = c ( v ) .$$

As outlined above, if the function c(j) is known to be zero for a j not in a set D, then the sum can be restricted to D as above.

A fifth approach combines some of the other approaches described above. The untrusted facility holds C documents, with each document c being associated with a set of index terms D^{(c)} and an identifier ID(c). The trusted facility wishes to know if any set of index terms for a document includes a query term v, and if there is one such document, it wishes to know the identifier of that document. For any particular document, c, the untrusted facility computes the same quantity as used in the second approach:

$${\tilde{r}}_{c} = {\sum }_{j ∈ {D}^{( c )}} ( {\prod }_{i} {f}_{i} ( {w}_{i} ) ) ,$$

where the wᵢ are the bit representation of

$$j = {\sum }_{i} {w}_{i} {2}^{i - 1} ,$$

and then computes a sum over all the documents

$$\tilde{r} = {\sum }_{c} ID ( c ) {\tilde{r}}_{c}$$

After de-obfuscation, the arithmetic result is

$$r = {ρ}^{- 1} ( \tilde{r} ) = {\sum }_{c} ID ( c ) {ρ}^{- 1} ( {\tilde{r}}_{c} ) = {\sum }_{c} ID ( c ) {r}_{c} .$$

### Because

$${r}_{c} = {\sum }_{j ∈ {D}^{( c )}} ( {\prod }_{i} {x}_{i} ( {w}_{i} ) )$$

is only greater than a threshold

$${\prod }_{i} {x}_{i} ( {u}_{i} )$$

(for the desired query term

$$v = {\sum }_{i} {u}_{i} {2}^{i - 1} ) if v ∈ {D}^{( c )} .$$

If there are no documents that have the query term, then the entire sum

$$r = {\sum }_{c} ID ( c ) {r}_{c}$$

is below the threshold. If there is exactly one document with the query term, then the index can be recovered as

$$ID = r div {\prod }_{i} {x}_{i} ( {u}_{i} ) ,$$

if it is above the threshold,

$$ID = {r}_{c} div {\prod }_{i} {x}_{i} ( {u}_{i} )$$

for similar reasons as set forth in the fourth example above. If there are multiple matching documents, then a sum of IDs is produce by the division. Depending on the structure of the ID numbers, such multiple IDs may be detected by the trusted facility, and depending on the structure of the IDs may in some embodiments be separated into the individual terms (e.g., using an error correcting approach).

In a sixth approach, the trusted facility has a set of query terms V={v₁, . . . , v_{Q}}, and wishes to know if any document has all the query terms in its set of index terms, and if there is one such document, the trusted facility wishes to know the index of that document. The trusted facility provides a separate f^{(q)} for each v_{q}, as in the third approach above. For any particular document, m, the untrusted facility computes the same quantity as used in the third approach:

$${\tilde{r}}_{m} = {\prod }_{q = 1}^{Q} ( {\sum }_{j ∈ {D}^{( m )}} ( {\prod }_{i} {f}_{i}^{( q )} ( {w}_{i} ) ) ) ,$$

where the wᵢ are the bit representation of

$$j = {\sum }_{i} {w}_{i} {2}^{i - 1} ,$$

and again returns

$$\tilde{r} = {\sum }_{m} ID ( m ) {\tilde{r}}_{m}$$

and the ID is recovered at the trusted facility by dividing the un-obfuscated result r by

$${\prod }_{q} ( {\prod }_{i} {x}_{i}^{( q )} ( {u}_{i}^{( q )} ) ) rather than {\prod }_{i} {x}_{i} ( {u}_{i} ) .$$

As a variant of this approach, instead the set of Q query terms, the trusted facility may specify a phrase made up of a sequence of Q individual query terms. In that case, \tilde{r}ₘ is computed in a similar manner as a Boolean test at each position of document m to determine whether the desired phrase is present at that position.

Once the trusted facility knows the document ID for the document it has found, it can retrieve successive portions of it using the fourth approach described above. For example, successive words of a document can be retrieved in this way without disclosing which document is desired.

In a seventh approach, to deal with a situation in which there are typically a number of documents that match the query, a number of separate sums are computed by the untrusted facility. The documents are partitioned according to a mapping (hash) function h(ID) which produces an value in the range 1 through H. Each document m contributes its value \tilde{r}ₘ to a sum \tilde{r}^{(h)} for h=h(ID(m)). That is:

\tilde{r}^{(h)}=Σ_{m:h(ID(m))=h}ID(m)\tilde{r}ₘ.

Each of the H sums are returned, and for each corresponding part, the trusted facility determines whether there are 0, 1, or multiple matching documents in that part. In this way, by choosing H, the chance of multiple documents per part can be reduced. In some examples, the trusted facility chooses H and passes it to the untrusted facility.

In some examples, the trusted facility then requests one document from each part: a random document if no matching documents or multiple matching documents were found, and the matching document if exactly one was found.

In some examples, a different mapping function is used for each interaction, therefore if the same query is sent to the untrusted facility, multiple matches in one part can be resolved by resubmitting the same query.

An Appendix is provided, which describes one or more embodiments of the approach described above. The Appendix also provides possible performance and security analyses for certain embodiments, however, it should be understood that embodiments do not necessarily match these analyses while still being within the scope of the invention.

The invention and all of the functional operations described in this specification can be implemented in digital electronic circuitry, or in computer hardware, firmware, software, or in combinations thereof. The invention can be implemented as one or more computer program products, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

It is to be understood that the foregoing description is intended to illustrate and not to limit the scope of the invention, which is defined by the scope of the appended claims. Other embodiments are within the scope of the following claims.

What is claimed is:

1. A method for processing one or more terms comprising:
at a first computation facility, computing an obfuscated numerical representation for each of the terms;
providing the computed obfuscated representations from the first facility to a second computation facility;
receiving at the first entity a result of an arithmetic computation based on the provided obfuscated values representing an obfuscation of a result of application of a first function to the terms; and
processing the received result to determine the result of application of the first function to the terms.

2. The method of claim 1 wherein the first function represents an identification of one or more data items available to the second facility that are each associated with each of the one or more terms.

3. The method of claim 2 wherein each term represents a corresponding keyword, and the data items represent documents, such that the first function represents a retrieval of identifications of documents that include all the keywords.

4. The method of claim 1 wherein the one or more terms are maintained to be private to the first facility without disclosure to the second facility.

5. The method of claim 1 further comprising providing a specification of the first function from the first facility to the second facility.

6. The method of claim 1 wherein computing the obfuscated numerical representation of each of the terms includes applying an obfuscation operator, wherein applying the obfuscation operator includes mapping an argument of the operator to a substantially random value of a range of numerical values, the range of numerical values being selected from pre-determined ranges based on the value of the argument.

7. The method of claim 6 wherein applying the obfuscation operator further includes adding a random multiple of a number.

8. The method of claim 7 wherein the number is based on one or more prime numbers.

9. The method of claim 6 wherein the pre-determined ranges comprise a first range of values and a second range of values, all the values in the first range being substantially smaller than all the values in the second range.

10. The method of claim 1 wherein computing the obfuscated numerical representation of each of the terms includes applying an obfuscation operator, wherein applying the obfuscation operator includes mapping an argument of the operator to set of numbers, each number based on the argument and a corresponding reference number.

11. The method of claim 10 wherein the reference numbers are relatively prime, and the each of the set of numbers is based on a modulus of the argument and the reference number.

12. The method of claim 1 wherein the first facility comprises a client process and the second facility comprises a server process, the client and server processes being coupled by a data link.

13. The method of claim 1 wherein the first function comprises an integer arithmetic function.

14. The method of claim 13 wherein the arithmetic function comprises a sum of quantities.

15. The method of claim 1 wherein the first function comprises a combination of a selection of a plurality of quantities known to the second facility, the selection being maintained private from the second facility.

16. The method of claim 1 wherein the first function comprises a Boolean expression.

17. The method of claim 16 wherein the Boolean expression includes both conjunction and disjunction.

18. The method of claim 16 wherein the Boolean expression includes at least one term comprising a conjunction of three or more sub-expressions.

19. The method of claim 16 wherein the Boolean expression is in conjunctive normal form.

20. The method of claim 16 wherein the Boolean expression is in disjunctive normal form.

21. A method for determining presence of a desired identifier in a set of identifiers, the desired identifier and each in the set of identifiers being represented as a series of values from a domain of valid values, the method comprising:
for each of the series of values of the desired identifier, computing a corresponding obfuscated representation of said value;
providing the obfuscated representations of the values;
receiving a numerical value computed based on the provided obfuscated representations and the representations of the identifiers in the set; and
determining whether the desired identifier is present in the set of identifiers based on the received numerical value.

22. The method of claim 21 wherein the domain of valid values consist of the possible bit values, and each of the series of values consists of a binary representation of a corresponding identifier.

23. The method of claim 21 wherein providing the obfuscated representations of the values includes, for each of the values providing an obfuscated representation associated with each of the values in the domain of valid values.

24. The method of claim 21 further comprising providing obfuscated representations of the series of values representing each of a series of identifiers specifying a desired phrase, and determining whether the desired phase is present according the received numerical value.

25. A method for determining presence of each of three or more desired identifiers in a set of identifiers, the method comprising:
for each of the desired identifiers, computing a corresponding obfuscated representation of said desired identifier;
providing the obfuscated representations of the identifiers;
receiving a numerical value computed based on the provided obfuscated representations and the identifiers in the set; and
determining whether all of the desired identifiers are present in the set of identifiers based on the received numerical value.

26. The method of claim 25 wherein each of at least some of the identifiers is associated with presence of a corresponding term.

27. The method of claim 25 wherein each of at least some of the identifiers is associated with absence of a corresponding term.

28. A data processing system comprising:
a first computation facility configured to compute an obfuscated numerical representation for each of a set of one or more terms known to the first facility; and
a second computation facility configured to receive the computed obfuscated representations from the first entity to a second facility and to compute a result of an arithmetic computation based on the received obfuscated values, the result representing an obfuscation of a result of application of a first function to the terms; and
wherein the first computation facility is further configured to receive the result from the second facility and to process the result to determine the result of application of the first function to the terms.

29. Software stored on computer-readable media comprising instructions for causing a data processing system to:
at a first computation facility, compute an obfuscated numerical representation for each of the terms;
provide the computed obfuscated representations from the first facility to a second computation facility;
receive at the first entity a result of an arithmetic computation based on the provided obfuscated values representing an obfuscation of a result of application of a first function to the terms; and
process the received result to determine the result of application of the first function to the terms.
